(19) United States
(12) Patent Application Publication
(10) Pub. No.: US 2026/0350426 A1
(43) Pub. Date: Nov. 5, 2026

(54) INTERACTIVE PROCESSING METHOD, ELECTRONIC DEVICE, AND STORAGE MEDIUM

(71) Applicant: Lenovo (Beijing) Limited, Beijing (CN)

(72) Inventor: Yuwen CHEN, Beijing (CN)

(21) Appl. No.: 19/660,157

(22) Filed: Apr. 27, 2026

(30) Foreign Application Priority Data
Apr. 30, 2025 (CN) 202510571371.3

(51) Int. Cl. G06N 5/022; G06F 16/215; G06F 16/34

(52) U.S. Cl. CPC G06N 5/022; G06F 16/215; G06F 16/345

(57) ABSTRACT

An interactive processing method includes: in response to obtaining target input data, retrieving, from a target knowledge base, first memory data and second memory data that match the target input data; and, performing generation processing on the target input data with reference to the first memory data and the second memory data, to obtain a target response result matching a target user intent. The target input data is data input to a target application, and the target application is capable of providing an artificial intelligence service or invoking at least one processing model to provide an artificial intelligence service, the at least one processing model including a target processing model. Configuration parameters respectively associated with the first memory data and the second memory data are different, and the target user intent is determined at least based on the target input data.

### CROSS-REFERENCES TO RELATED APPLICATIONS

The present disclosure claims priority to Chinese Patent Application No. 202510571371.3, filed on Apr. 30, 2025, the content of which is incorporated herein by reference in its entirety.

### TECHNICAL FIELD

The present disclosure relates to the field of artificial intelligence technologies, and more specifically, relates to an interactive processing method and an electronic device.

### BACKGROUND

In artificial intelligence applications or applications that are capable of calling artificial intelligence processing, it is required to provide a capability to perform personalized conversations with a user. Implementation of the personalized conversation is required to be completed based on historical interaction content with the user and user information. That is, during a conversation with the user, historical memory data having the highest relevance to the conversation context may be retrieved in real time. Based on the historical memory data, a large language model used for interaction is able to generate interactive responses that are more personalized, targeted, and consistent.

### SUMMARY

One aspect of the present disclosure provides an interactive processing method, The interactive processing method includes: in response to obtaining target input data, retrieving, from a target knowledge base, first memory data and second memory data that match the target input data; and, performing generation processing on the target input data with reference to the first memory data and the second memory data, to obtain a target response result matching a target user intent. The target input data is data input to a target application, and the target application is capable of providing an artificial intelligence service or invoking at least one processing model to provide an artificial intelligence service, the at least one processing model including the target processing model. Configuration parameters respectively associated with the first memory data and the second memory data in the target knowledge base are different, and the target user intent is determined at least based on the target input data.

Another aspect of the present disclosure provides an electronic device. The electronic device includes: one or more processors; and, a memory storing instructions that, when executed by the one or more processors, cause the electronic device to perform operations. The operations include: in response to obtaining target input data, retrieving, from a target knowledge base, first memory data and second memory data that match the target input data; and, performing generation processing on the target input data with reference to the first memory data and the second memory data, to obtain a target response result matching a target user intent. The target input data is data input to a target application, and the target application is capable of providing an artificial intelligence service or invoking at least one processing model to provide an artificial intelligence service, the at least one processing model including the target processing model. Configuration parameters respectively associated with the first memory data and the second memory data in the target knowledge base are different, and the target user intent is determined at least based on the target input data.

Yet another aspect of the present disclosure provides a non-transitory computer-readable storage medium storing instructions that, when executed by at least one processor, cause the at least one processor to perform operations. The operations include: in response to obtaining target input data, retrieving, from a target knowledge base, first memory data and second memory data that match the target input data; and, performing generation processing on the target input data with reference to the first memory data and the second memory data, to obtain a target response result matching a target user intent. The target input data is data input to a target application, and the target application is capable of providing an artificial intelligence service or invoking at least one processing model to provide an artificial intelligence service, the at least one processing model including the target processing model. Configuration parameters respectively associated with the first memory data and the second memory data in the target knowledge base are different, and the target user intent is determined at least based on the target input data.

### BRIEF DESCRIPTION OF THE DRAWINGS

To more clearly illustrate the technical solutions of the embodiments of the present disclosure or the existing technology, the accompanying drawings required for describing the embodiments or the existing technology are briefly introduced below. It is apparent that the accompanying drawings described below merely illustrate some embodiments of the present disclosure, and those of ordinary skill in the art may obtain other drawings based on these drawings without involving inventive effort.

FIG. 1 illustrates a flowchart of an interactive processing method in accordance with some embodiments of the present disclosure.

FIG. 2 illustrates a schematic diagram of an overall implementation architecture of an interactive processing solution in accordance with some embodiments of the present disclosure.

FIG. 3 illustrates a schematic diagram of a data processing flow of a target knowledge base in accordance with some embodiments of the present disclosure.

FIG. 4 illustrates a flowchart of retrieving and matching memory data in accordance with some embodiments of the present disclosure.

FIG. 5 illustrates a schematic flow diagram of recalling recent specific event data and long-term important data in accordance with some embodiments of the present disclosure.

FIG. 6 illustrates a schematic structural diagram of an interactive processing apparatus in accordance with some embodiments of the present disclosure.

FIG. 7 illustrates a schematic structural diagram of an electronic device in accordance with some embodiments of the present disclosure.

### DETAILED DESCRIPTION

The technical solutions of the embodiments of the present disclosure will be clearly and completely described below with reference to the accompanying drawings. It is apparent that the described embodiments are only some embodiments of the present disclosure rather than all embodiments. Based on the embodiments of the present disclosure, all other embodiments obtained by those of ordinary skill in the art without inventive effort fall within the protection scope of the present disclosure.

The embodiments of the present disclosure may be applied to an electronic device. The form of the electronic device is not specifically limited in the present disclosure, and may include, but is not limited to, a smartphone, a tablet computer, a wearable device, a personal computer (PC), a notebook computer, and the like, which may be selected according to application requirements.

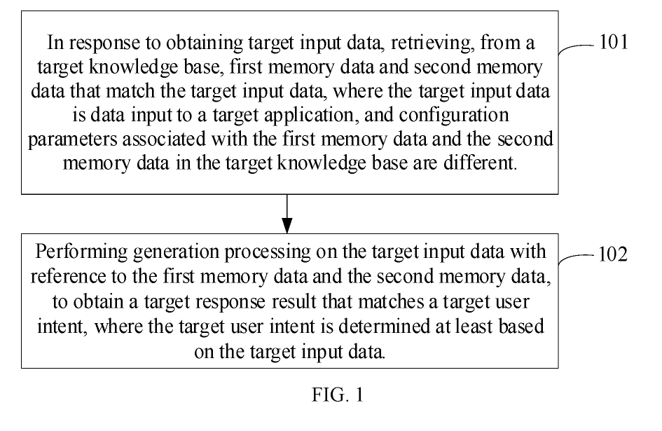

FIG. 1 illustrates a flowchart of an interactive processing method in accordance with some embodiments of the present disclosure. As shown in FIG. 1, the interactive processing method may include Step 101 and Step 102 as follows.

Step 101: in response to obtaining target input data, retrieving, from a target knowledge base, first memory data and second memory data that match the target input data, where the target input data is data input to a target application, and the target application is capable of providing an artificial intelligence service or invoking at least one processing model to provide an artificial intelligence service.

Specifically, the target application may be an agent application, or an application capable of invoking an AI model or an agent application, such as Lenovo’s agent application (e.g., Lenovo Xiaotian or AI NOW), or an application capable of invoking an AI model, such as a WeChat application, Lenovo’s image generation application Creator Zone, a browser application, a chatbot application, an image application, and the like. The target input data may be interaction data input to the target application, such as conversation data input to a conversation box or a data input box of the target application, control action data, instruction data, and the like. The data type of the target input data is not specifically limited, and may include, but is not limited to, voice data, string data, image data, gesture interaction data, and other multimodal data.

The target knowledge base may be a local knowledge base or a cloud knowledge base. Specifically, the target knowledge base may be a personal knowledge base, a household knowledge base, a team collaboration knowledge base, or a knowledge base of an organization such as an enterprise or a school. The target knowledge base stores memory data of one or more users having access permissions to the knowledge base. The memory data may include content generated in users’ daily life or work, such as text, voice, images, audio, video, and the like.

The target knowledge base includes at least first memory data and second memory data, where configuration parameters associated with the first memory data and the second memory data are different. The configuration parameters may include, but are not limited to, tag information such as generation time, location, and source of the memory data or corresponding events.

For example, the configuration parameters may include at least one of a storage location, a divided time interval range, a storage form, an importance level, or a priority. Specifically, memory data may be processed and stored according to a length of time since generation or storage. For example, the first memory data may include specific event data within a first historical time period that has a first degree of relevance to the target input data, and original memory data associated with the specific event data. The second memory data may include important event data outside the first historical time period that has a second degree of relevance to the target input data, and original memory data associated with the important event data. The specific event data is obtained based on processing of the original memory data, and the important event data is obtained based on processing of the specific event data. Types and corresponding contents of memory data included in the target knowledge base will be described in detail in subsequent embodiments and will not be further elaborated herein.

The first memory data and the second memory data that match the target input data may be memory data having a similarity to the target input data that reaches a specified threshold. The similarity may be determined based on, for example, a cosine similarity, a vector distance and the like of two matching objects, and will not be further described herein. Since the first memory data and the second memory data have a certain degree of similarity to the target input data, they may be used as prompt optimization materials corresponding to the target input data, may be used as reference bases for model parameter adjustment, or may be used as a database for retrieval enhancement.

Step 102: performing generation processing on the target input data with reference to the first memory data and the second memory data, to obtain a target response result that matches a target user intent.

After determining the first memory data and the second memory data, the target response result matching the target user intent may be generated based on the target input data and by using the first memory data and the second memory data as a reference. The target user intent is determined at least based on the target input data. For example, when the target input data is “generate an image of a puppy,” the generated target response result may be an image of “a puppy sitting on grass,” which satisfies a basic requirement of the target input data.

The target user intent may further be determined based on additional data besides the target input data, such as the first memory data, the second memory data, a scene where the user is located, or user occupation data. For example, when a portion of the first memory data related to animals indicates that animals are consistently white in color, and the user occupation data indicates that the user is an advertising designer, and the target input data is “generate an image of a puppy,” the generated target response result may be an image of “a white puppy with a background including blank space.” Here, the color “white” of the puppy is determined with reference to the memory data, and the blank background is determined with reference to the user’s profession as an advertising designer. Advertising images often require overlaying text, and thus backgrounds are designed to be simple to avoid affecting readability and visual perception. The generated target response result not only satisfies the basic requirement of the target input data, but also reflects the user’s preferences and usage needs, thereby better matching the user intent.

Alternatively, the target user intent may be determined based on other types of data, such as trending data or current event data related to content in the target input data. For example, when the target input data is “what are traditional activities during the Dragon Boat Festival,” the model may automatically retrieve recently popular information, such as news related to dragon boat racing events, and use such information as reference content for generating the target response result.

The target response result may include, but is not limited to, a conversational reply corresponding to the target input data, a multimedia data file, a text file, a control instruction (such as an instruction for adjusting device configuration parameters or controlling another device), or a processing task (such as generating a task to be executed). For example, in a household scenario, a user may invoke an intelligent assistant and input a voice command such as “What is the indoor temperature? I feel a bit warm.” The corresponding target response result may include both a voice reply and a control instruction. The voice reply may be “The current indoor temperature is 26 ℃. The air conditioner has been turned on,” and the control instruction may instruct an air-conditioning device to start and operate in a cooling mode.

According to some embodiments of the present disclosure, after obtaining the target input data, the interactive processing method is able to retrieve, from a target knowledge base that includes memory data having different configuration parameters, first memory data and second memory data having relatively high similarity to the target input data. Since the configuration parameters of the first memory data and the second memory data are different, matching between the target input data and the memory data may be performed more accurately and efficiently from different dimensions, thereby obtaining a target response result that better matches the target user intent.

To facilitate a better understanding and implementation of the technical solutions of the present disclosure, memory data in a target knowledge base is first introduced.

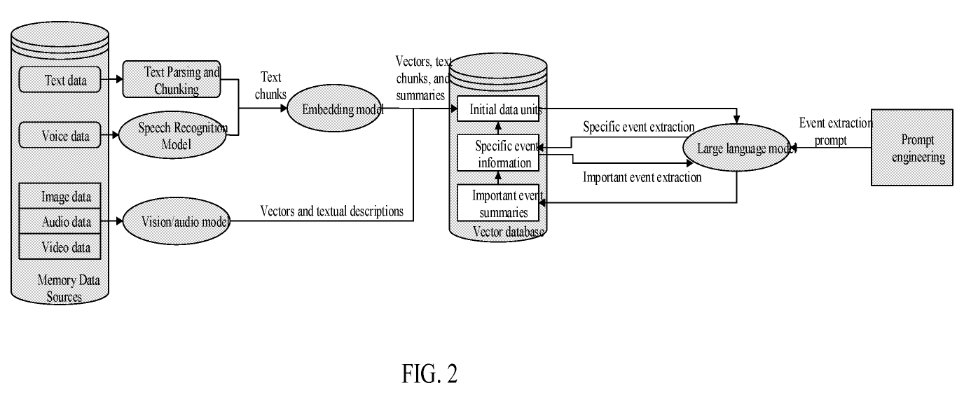

FIG. 2 illustrates a schematic diagram of an overall implementation architecture of an interactive processing solution in accordance with some embodiments of the present disclosure. As shown in FIG. 2, content corresponding to user behaviors in daily life or work, such as conversations, activities, or device operations, may serve as sources of memory data. Such content may include text, voice, images, audio, video, and the like, as well as associated data such as time, location, and participants corresponding to the content. The content may be vectorized by using models (including a word embedding model, a language model, a speech model, a vision/audio model, and the like), and textual descriptions or event summaries may be extracted to serve as original memory data, which is stored in the target knowledge base (corresponding to a vector database in FIG. 2).

Further, based on vector distances among different original memory data, original memory data with related content may be clustered. A content summary of each cluster may be extracted, and specific event information may be extracted from the cluster summaries and corresponding original memory data, to generate specific event data. The specific event data may be stored in the target knowledge base and associated with the original memory data. In some embodiments, the extracted specific event data may be merged and/or deduplicated to reduce data storage and improve subsequent retrieval efficiency.

Further, based on vector distances among the specific event data, content-related specific event data may be clustered. A content summary of a current cluster is extracted from each set of cluster data, and an important event summary is extracted from each set of cluster content summaries and related specific event data The important event data may be stored in the target knowledge base and associated with the specific event data. Similarly, the extracted important event data may be merged and/or deduplicated.

In application scenarios, memory data may be divided into recent (short-term) data and distant (long-term) data according to a predetermined time period. Recent data may be processed to obtain corresponding specific event data, while distant data may be processed to obtain corresponding important event data.

For example, a time period of six months may be used as a boundary. Original memory data within the past six months may be processed to obtain corresponding specific event data, while specific event data prior to six months may be further processed to obtain important event data.

Referring to FIG. 2, the word embedding model is configured to perform vectorization processing on text; the speech recognition model is configured to convert user voice conversations into textual content and participant labels; the vision model is configured to perform vectorization processing and content understanding on images and videos to generate textual descriptions; the audio model is configured to perform vectorization processing and content understanding on audio to generate textual descriptions; and a large language model is configured to extract information from textual data. Event extraction prompts may be used to prompt the large language model to extract event-format information, including events, locations, participants, and the like.

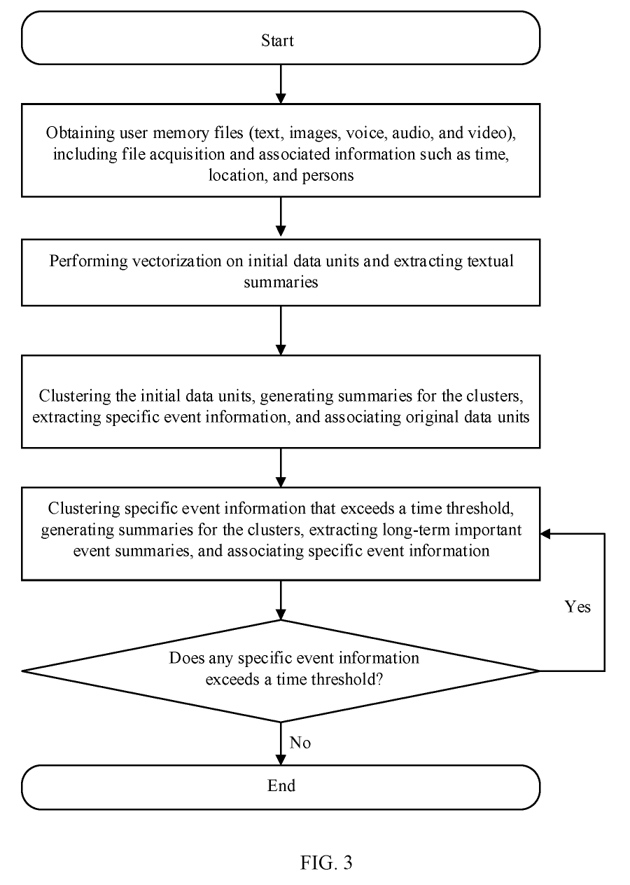

FIG. 3 illustrates a schematic diagram of a data processing flow of the target knowledge base in accordance with some embodiments of the present disclosure. With reference to FIG. 3 and the foregoing embodiments, a hierarchical storage structure of the target knowledge base including original memory data, specific event data, and important event data may be understood. Since the memory data in the target knowledge base is stored in a hierarchical structure, specific event data may be emphasized for recent memory data, and important event data may be emphasized for distant memory data, thereby highlighting key information and facilitating identification of data that is valuable relative to the target input data. In addition, the memory data in the target knowledge base further includes explicit key information such as time, location, participants, and events, which enables more targeted data recall and contributes to more accurate and efficient retrieval and matching in subsequent processing.

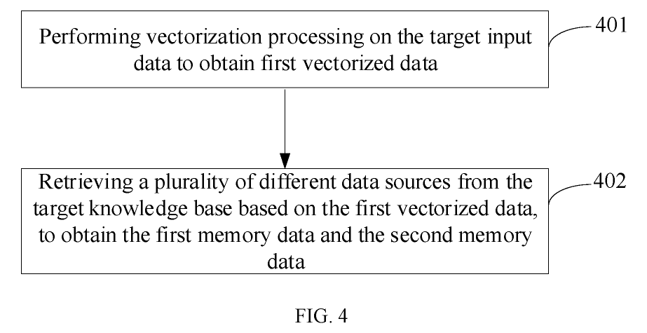

FIG. 4 illustrates a flowchart of retrieving and matching memory data in accordance with some embodiments of the present disclosure. Referring to FIG. 4, in the foregoing embodiments, retrieving, from the target knowledge base, first memory data and second memory data that match the target input data may include Step 401 and Step 402.

Step 401: performing vectorization processing on the target input data to obtain first vectorized data.

That is, the target input data is converted from its original data type into vector data in a unified manner. For target input data having a data type of text, the first vectorized data may be directly obtained based on the textual content. For target data having a data type of non-text, such as voice data, image data, or video data, the target input data may first be converted into textual content using a speech recognition model, a vision/audio model, a word embedding model, and the like, and then the converted textual content may be further converted into the first vectorized data.

Here, performing vectorization processing on the target input data to obtain the first vectorized data facilitates subsequent similarity comparison between the target input data and the memory data in a quantitative manner.

Step 402: retrieving a plurality of different data sources from the target knowledge base based on the first vectorized data, to obtain the first memory data and the second memory data.

Information in at least one data field differs among the plurality of different data sources, and retrieval modes for the plurality of different data sources may be the same or different. The first memory data may be recent memory data or short-term memory data, and the second memory data may be distant memory data or long-term memory data. The information in at least one data field differs among the plurality of different data sources may be reflected in differences in descriptive tags between recent memory data and distant memory data. The plurality of different data sources may include, for example, specific event data and important event data.

In a specific implementation, the first memory data may include specific event data and associated original memory data, and the second memory data may include important event data and associated original memory data.

A specific implementation of Step 402 may include: retrieving, from the target knowledge base, a first data source based on the first vectorized data using a first retrieval mode, to obtain the first memory data, where the first data source is a data set obtained by performing a first processing on first user data of a target user acquired within a first time period; and retrieving, from the target knowledge base, a second data source based on the first vectorized data using a second retrieval mode, to obtain the second memory data, where the second data source is a data set obtained by performing a second processing on second user data of the target user acquired within a second time period, or the second data source is a data set obtained by performing a third processing on the first data source.

Specifically, the first retrieval mode and the second retrieval mode may be the same or different. The first retrieval mode may include, but is not limited to, semantic vector retrieval, keyword-based vector retrieval, or tag-based vector retrieval. The first time period is later than the second time period, and the first processing is different from the second processing.

The first data source may correspond to the aforementioned specific event data and correspond to recent memory data, and the second data source may correspond to the aforementioned important event data and correspond to distant memory data. In some embodiments, a boundary between recent and distant data (i.e., the first time period) may be preset by default or may be defined according to an application scenario. For example, the first time period may be within six months or within one year. The first user data within the first time period may include user data generated in contexts such as home, work, or travel and leisure, including device operation data, social interaction data, activity-related data or event data, or social relationship data (such as family relationships or work relationships), corresponding to the memory data sources shown in FIG. 2. Correspondingly, the second time period may be earlier than six months or one year, and the second user data may be the same as or different from the first user data, also corresponding to the memory data sources shown in FIG. 2.

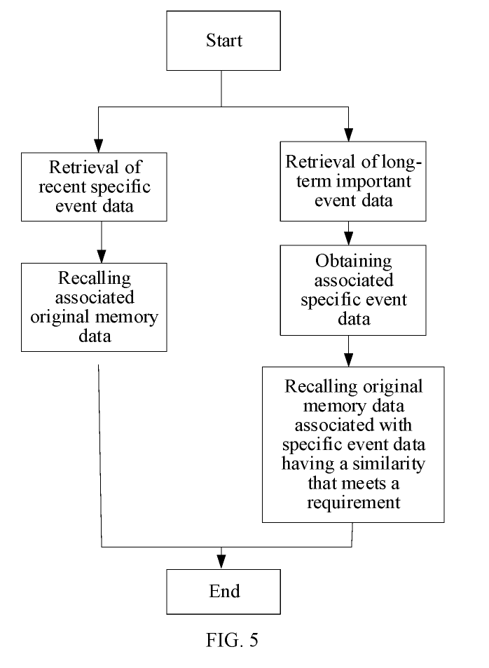

FIG. 5 illustrates a schematic flow diagram of recalling recent specific event data and distant important event data in accordance with some embodiments of the present disclosure. As shown in FIG. 5, recall of recent specific event data and recall of distant important event data may be performed concurrently in parallel to ensure data processing efficiency. The implementation of the interactive processing solution of the present disclosure may be understood with reference to FIG. 5.

The first processing may include extracting textual descriptions according to fields such as time, location, participants, and events, and associating the textual descriptions with original data units. A specific implementation corresponds to the process of obtaining specific event data described above, including clustering original memory data, extracting summaries for each cluster, and extracting specific event information from the summaries and the original memory data. The second processing may include clustering original memory data, extracting summaries for each cluster, performing clustering again based on the summaries, and extracting summaries again.

Specifically, performing the first processing on user data of the target user acquired within the first time period to obtain a first data source may include: performing vectorization processing on first user data of the target user acquired within the first time period to obtain a plurality of sets of second vectorized data; performing first clustering processing on the plurality of sets of second vectorized data to obtain a plurality of first vectorized data sets; performing first summary generation processing on the plurality of first vectorized data sets to obtain a first summary data set; and performing extraction processing on the first summary data set and the first user data according to a first data structure to obtain the first data source.

Performing first clustering processing on the plurality of sets of second vectorized data to obtain the plurality of first vectorized data sets may be based on a same vector distance, or may be based on different vector distances. That is, clustering may be performed by adaptively adjusting vector distances based on an event type or a scene type. For example, in a learning event type, clustering may be performed based on a first vector distance, while in a travel event type, clustering may be performed based on a second vector distance.

The process of performing first summary generation processing on the plurality of first vectorized data sets may be implemented by using a same model as the clustering processing, or by using another different model. That is, the processes included in the first processing may be performed by a single large model, or different processes in the first processing may be performed by a plurality of different smaller models.

Performing extraction processing on the first summary data set and the first user data according to the first data structure may include extracting specific event information from cluster summaries and corresponding original memory data, and storing the extracted information as specific event data in the target knowledge base while associating the specific event data with the original memory data.

In other embodiments, obtaining the first data source may be implemented in different ways.

In another implementation, after obtaining the plurality of sets of second vectorized data, extraction processing may be directly performed on the plurality of sets of second vectorized data according to the first data structure to obtain the first data source. That is, after the plurality of sets of second vectorized data are obtained, event information is directly extracted from the vectorized data without clustering processing to obtain the first data source.

In yet another implementation, after obtaining the first summary data set, extraction processing may be performed on the first summary data set and the plurality of sets of second vectorized data according to the first data structure to obtain the first data source. That is, after obtaining the first summary data set, event information may be extracted in combination with the vectorized data rather than the first user data. The first data structure may be determined based on prompt data input by a user (corresponding to the target input data), to determine an event format for extraction.

In still another implementation, merging and/or deduplication processing may be performed on event data obtained through extraction processing to obtain the first data source. That is, since duplicate content may exist in specific event data extracted from different clusters and original memory data, merging and/or deduplication may be performed on the extracted event data to reduce data storage.

Specifically, performing a third processing on the first data source to obtain a second data source may include: performing second clustering processing on the first data source to obtain a plurality of second vectorized data sets; performing second summary generation processing on the plurality of second vectorized data sets to obtain a second summary data set; and performing extraction processing on the second summary data set and the first data source according to a second data structure or performing third summary generation processing, to obtain the second data source.

That is, the second data source may be determined as a data set obtained by performing a third processing on the first data source. In this implementation, content-related specific event data is clustered for the first time based on vector distances (i.e., performing second clustering processing on the first data source), summaries are extracted for each cluster, and important event summaries are extracted from each cluster content summary and corresponding specific event data. The important event summaries are stored in the target knowledge base as important event data and are associated with the specific event data.

Specifically, performing the extraction processing or the third summary generation processing on the second summary data set and the first data source according to the second data structure may include extracting important event summaries, or generating summary content of important events based on important event labels or specific labels defined in the data structure.

In other embodiments, obtaining the second data source may be implemented in different ways.

Another implementation of obtaining the second data source is: processing the first data source into the second data source according to a first time interval. The first time interval may be set based on application requirements and is not specifically limited. For example, when the first time interval is 3 months, during operation of the solution, as time progresses, incremental portions of the first data source that exceed the three-month storage period (i.e., incremental distant specific event data) may be processed to become the second data source.

Yet another implementation of obtaining the second data source is: performing merging and/or deduplication processing on the second data source based on the first data source. This implementation may include two processes: extracting incremental distant specific event data to obtain incremental distant important event data, and comparing the incremental distant important event data with existing distant important event data, followed by merging and deduplication. The merged and deduplicated results may be stored as the second data source.

In other embodiments, processing of user data may further include invoking different processing models to perform vectorization processing on corresponding types of user data. Referring to FIG. 2, for text-type user data, a word embedding model may be invoked for vectorization processing; for voice-type user data, a speech recognition model may first be invoked to convert voice content into textual content, and then a word embedding model may be invoked to perform vectorization processing on the textual content; for video-type user data, a vision model may be invoked to perform corresponding vectorization processing; and for audio-type user data, an audio model may be invoked to perform corresponding vectorization processing.

The foregoing describes various implementations for processing user data and obtaining different data sources, but does not limit the manner in which data sources are obtained.

In the aforementioned embodiments, performing generation processing on the target input data with reference to the first memory data and the second memory data may include: using the first memory data and the second memory data as knowledge base data of a target processing model, and invoking, by the target processing model or a target application, the knowledge base data to perform generation processing on the target input data.

As used herein, the target processing model may be a processing model built into the target application, or a processing model that operates independently of the target application.

In one embodiment, the target processing model may be understood as the large language model shown in FIG. 2. After obtaining prompt data (i.e., the target input data), the model may retrieve the first memory data and the second memory data from the target knowledge base based on the prompt data, and generate a target response result with reference to the first memory data and the second memory data.

In another implementation, performing generation processing on the target input data with reference to the first memory data and the second memory data may include: updating prompt data corresponding to the target input data based on the first memory data and the second memory data, and performing generation processing on the updated prompt data using the target processing model.

For example, when the target input data is voice data “please explain the necessity of health care (Bao Jian),” the prompt data recognized by the large language model may include homophonic terms that are incorrectly recognized including "sword (Bao Jian)," "necessity," and the like. When the first memory data and the second memory data include a plurality of contents related to “health care,” such as health maintenance and immunity enhancement, it may be determined that the correct prompt data corresponds to “health care.” Accordingly, the prompt data may be updated based on the first memory data and the second memory data to improve accuracy.

In another implementation, performing generation processing on the target input data with reference to the first memory data and the second memory data may include: optimizing user intent corresponding to the target input data based on the first memory data and the second memory data, and performing generation processing on the optimized target user intent using the target processing model.

For example, when the target input data is “please introduce multimodal models,” an initial user intent may be determined as “understand the concept of multimodal models.” After obtaining the first memory data and the second memory data, when it is determined that such data includes a plurality of contents related to applications, functions, and scenarios of multimodal models, it may be inferred that the user already has a certain level of knowledge. Accordingly, the user intent may be updated to “provide an in-depth introduction to multimodal models,” and generation processing may be performed based on the updated intent.

In another implementation, performing generation processing on the target input data with reference to the first memory data and the second memory data may include: performing model parameter adjustment processing on the target processing model based on the first memory data and the second memory data, and performing generation processing on the target input data using the adjusted target processing model.

For example, during operation of the target processing model, user preferences reflected in historical memory data (e.g., a preference for concise or simple descriptions) may be identified based on the first memory data and the second memory data. Accordingly, model parameters of the target processing model may be adjusted so that the generated target response results align with the user’s preferences.

In another implementation, performing generation processing on the target input data with reference to the first memory data and the second memory data may include: adjusting weights of target data within the target input data based on the first memory data and the second memory data, and performing generation processing on the adjusted input data using the target processing model.

For example, when the target input data is “generate an image including a cat and a dog,” target elements may include “cat” and “dog,” with equal weights (e.g., 0.5 each). When the first memory data and the second memory data indicate that images of cats account for a relatively large proportion, and that in images including both cats and dogs the cat often appears as a foreground or near-field object, the weights of the target elements may be adjusted accordingly. For example, the weight of “cat” may be adjusted to 0.7 and the weight of “dog” may be adjusted to 0.3.

In another implementation, performing generation processing on the target input data with reference to the first memory data and the second memory data may include: generating third memory data based on weight parameters respectively corresponding to the first memory data and the second memory data.

In this implementation, the first memory data corresponds to recent data and may be assigned a larger weight (e.g., 0.7), while the second memory data corresponds to distant data and may be assigned a smaller weight (e.g., 0.3). The two sets of reference data (i.e., the first memory data and the second memory data) may be combined to generate the third memory data, and the third memory data may be used to assist the target processing model in performing generation processing. The combination may include weighted processing of the first memory data and the second memory data.

Based on the foregoing implementation, performing generation processing on the target input data with reference to the first memory data and the second memory data may further include: invoking the target processing model based on the third memory data to perform generation processing on the target input data, to obtain the target response result; or performing optimization processing on a response result obtained by the target processing model processing the target input data based on the third memory data, to obtain the target response result.

After obtaining the third memory data, the third memory data may be used as reference data for generating the target response result, or the first memory data and the second memory data may still be used as references to generate a response result, and the response result may be further optimized based on the third memory data to obtain the target response result.

The foregoing describes various implementations of performing generation processing on the target input data with reference to the first memory data and the second memory data, to facilitate understanding and implementation of the technical solutions of the present disclosure. The implementations of performing generation processing may be performed by the target processing model or the target application built with the target processing model.

For the foregoing method embodiments, for simplicity of description, the methods are described as a series of action combinations. However, those of ordinary skill in the art should understand that the present disclosure is not limited to the described order of actions, as certain steps may be performed in other orders or concurrently according to the present disclosure. In addition, those of ordinary skill in the art should also understand that the embodiments described in the specification are preferred embodiments, and the actions and modules involved are not necessarily required by the present disclosure.

The foregoing embodiments of the present disclosure describe methods in detail. Since the methods of the present disclosure may be implemented by apparatuses in various forms, the present disclosure further provides an apparatus, and specific embodiments thereof will be described in detail below.

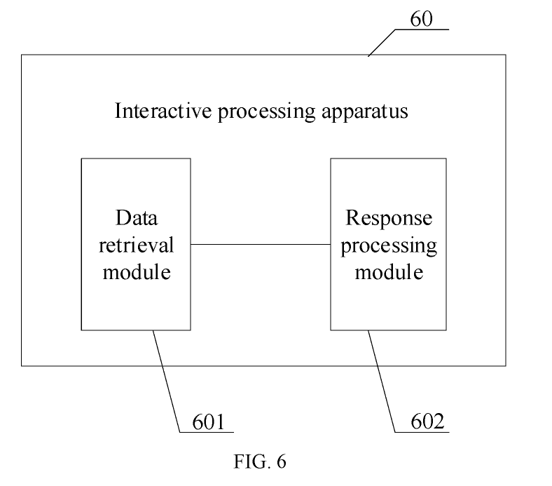

FIG. 6 illustrates a schematic structural diagram of an interactive processing apparatus in accordance with some embodiments of the present disclosure. Referring to FIG. 6, the interactive processing apparatus 60 may include:
a data retrieval module 601, configured to, in response to obtaining target input data, retrieve, from a target knowledge base, first memory data and second memory data that match the target input data, where the target input data is data input to a target application, and the target application is capable of providing an artificial intelligence service or invoking at least one processing model to provide an artificial intelligence service; and
a response processing module 602, configured to perform generation processing on the target input data with reference to the first memory data and the second memory data, to obtain a target response result that matches a target user intent.

The first memory data and the second memory data have different configuration parameters in the target knowledge base, and the target user intent is determined at least based on the target input data.

According to some embodiments of the present disclosure, after obtaining the target input data, the interactive processing apparatus is able to retrieve, from a target knowledge base that includes memory data having different configuration parameters, first memory data and second memory data that have relatively high similarity to the target input data. Since the configuration parameters of the first memory data and the second memory data are different, matching between the target input data and the memory data may be performed more accurately and efficiently from different dimensions, thereby obtaining a target response result that better matches the target user intent.

In some embodiments, the data retrieval module includes: a vectorization processing module configured to perform vectorization processing on the target input data to obtain first vectorized data; and, a retrieval processing module configured to retrieve a plurality of different data sources from the target knowledge base based on the first vectorized data, to obtain the first memory data and the second memory data. Information in at least one data field differs among the plurality of different data sources, and retrieval modes for the plurality of different data sources may be the same or different.

In some embodiments, the retrieval processing module is specifically configured to: retrieve, from the target knowledge base, a first data source based on the first vectorized data using a first retrieval mode, to obtain the first memory data, where the first data source is a data set obtained by performing a first processing on first user data of a target user acquired within a first time period; and retrieve, from the target knowledge base, a second data source based on the first vectorized data using a second retrieval mode, to obtain the second memory data, where the second data source is a data set obtained by performing a second processing on second user data of the target user acquired within a second time period, or the second data source is a data set obtained by performing a third processing on the first data source. The first retrieval mode and the second retrieval mode may be the same or different, the first time period is later than the second time period, and the first processing is different from the second processing.

In some embodiments, the apparatus may further include a data source processing module. The data source processing module obtaining the first data source may include: performing vectorization processing on first user data of the target user acquired within the first time period to obtain a plurality of sets of second vectorized data; performing first clustering processing on the plurality of sets of second vectorized data to obtain a plurality of first vectorized data sets; performing first summary generation processing on the plurality of first vectorized data sets to obtain a first summary data set; and performing extraction processing on the first summary data set and the first user data according to a first data structure to obtain the first data source.

In some embodiments, the data source processing module may further perform at least one of the following: after obtaining the plurality of sets of second vectorized data, performing extraction processing on the plurality of sets of second vectorized data according to the first data structure to obtain the first data source; after obtaining the first summary data set, performing extraction processing on the first summary data set and the plurality of sets of second vectorized data according to the first data structure to obtain the first data source; or performing merging and/or deduplication processing on event data obtained through the extraction processing to obtain the first data source.

In some embodiments, the apparatus may further include a data source processing module, where obtaining the second data source by the data source processing module may include: performing second clustering processing on the first data source to obtain a plurality of second vectorized data sets; performing second summary generation processing on the plurality of second vectorized data sets to obtain a second summary data set; and performing extraction processing or third summary generation processing on the second summary data set and the first data source according to a second data structure to obtain the second data source.

In some embodiments, the data source processing module may further be configured to perform at least one of the following: processing the first data source into the second data source according to a first time interval; performing merging and/or deduplication processing on the second data source based on the first data source; invoking different processing models to perform vectorization processing on corresponding types of user data; or, associating user data or vectorized data corresponding to the first data source with user data or vectorized data corresponding to the second data source.

In some embodiments, the response processing module may be configured to perform at least one of the following: using the first memory data and the second memory data as knowledge base data of a target processing model, and invoking, by the target processing model, the knowledge base data to perform generation processing on the target input data; updating prompt data corresponding to the target input data based on the first memory data and the second memory data, and performing generation processing on updated prompt data using the target processing model; optimizing user intent corresponding to the target input data based on the first memory data and the second memory data, and performing generation processing on optimized target user intent using the target processing model; performing model parameter adjustment processing on the target processing model based on the first memory data and the second memory data, and performing generation processing on the target input data using the adjusted target processing model; or, adjusting a weight of target data in the target input data based on the first memory data and the second memory data, and performing generation processing on the adjusted input data using the target processing model.

In some embodiments, the response processing module may further be configured to perform at least one of the following: generating third memory data based on weight parameters respectively corresponding to the first memory data and the second memory data; or, invoking the target processing model based on the third memory data to perform generation processing on the target input data, to obtain the target response result; or, performing optimization processing on a response result obtained by the target processing model processing the target input data based on the third memory data, to obtain the target response result.

Specific implementations of the interactive processing apparatus and the modules included therein may refer to the corresponding descriptions in the method embodiments and will not be repeated herein.

In the foregoing embodiments, any of the interactive processing apparatuses may include a processor and a memory. The data retrieval module, the response processing module, the vectorization processing module, the retrieval processing module, the data source processing module, and the like may be stored in the memory as program modules, and the processor may execute the program modules stored in the memory to implement corresponding functions.

The processor may include one or more cores, and the cores may invoke corresponding program modules from the memory. One or more cores may be configured, and processing of returned data may be implemented by adjusting parameters of the cores.

The memory may include non-transitory storage media in a computer-readable medium, such as a random access memory (RAM) and/or non-volatile memory, for example, a read-only memory (ROM) or a flash memory (flash RAM). The memory may include at least one storage chip.

In some exemplary embodiments, a computer-readable storage medium is further provided. The computer-readable storage medium may be directly loaded into an internal memory of a computer, and includes software code. When the computer program is loaded and executed by a computer, the computer program may implement the steps of any of the embodiments of the interactive processing method described above.

In some exemplary embodiments, a computer program product is further provided. The computer program product may be directly loaded into an internal memory of a computer and includes software code. When the computer program is loaded and executed by a computer, the computer program may implement the steps of any of the embodiments of the interactive processing method described above.

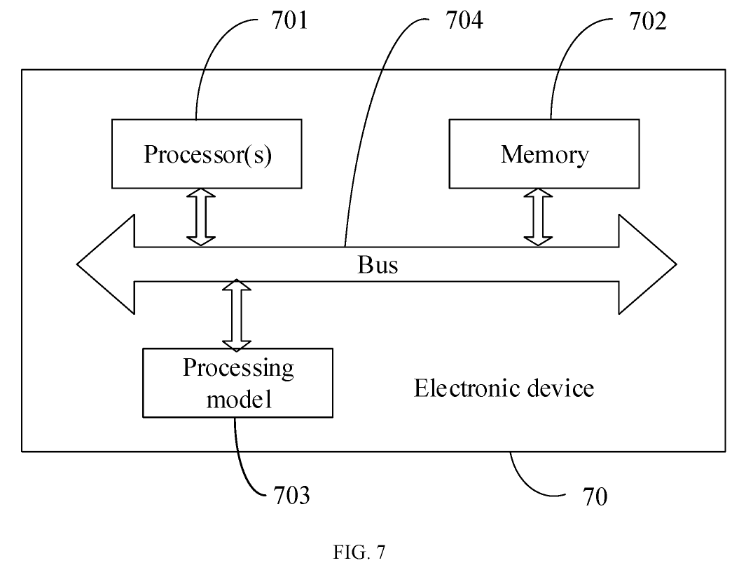

Further, the embodiments of the present disclosure provide an electronic device. FIG. 7 illustrates a schematic structural diagram of an electronic device in accordance with some embodiments of the present disclosure. Referring to FIG. 7, an electronic device 70 includes at least one processor 701, at least one memory 702 connected to the processor, at least one processing model 703 capable of running on the processor, and a bus 704. The processor, the memory, and the processing model communicate with each other via the bus. The processing model may be invoked by a target application to perform at least one of the following:
in response to obtaining target input data, retrieving, from a target knowledge base, first memory data and second memory data that match the target input data, where the target input data is data input to the target application, and the target application is capable of providing an artificial intelligence service or invoking at least one processing model to provide an artificial intelligence service; and
performing generation processing on the target input data with reference to the first memory data and the second memory data, to obtain a target response result that matches a target user intent,
where configuration parameters associated with the first memory data and the second memory data in the target knowledge base are different, and the target user intent is determined at least based on the target input data.

In some embodiments, the processing model in the electronic device may further be invoked to perform: in response to obtaining target input data, performing a corresponding retrieval operation in the target knowledge base according to a target retrieval strategy.

The target retrieval strategy is obtained by configuring a plurality of different retrieval modes based on target scoring data, and may include one or more retrieval strategies. The configuration may include adjusting initial weights of the retrieval modes, configuring whether the retrieval modes are executed in parallel or in series, and selecting one retrieval mode or a combination of retrieval modes.

In implementations where the target retrieval strategy includes a plurality of retrieval strategies, the plurality of retrieval strategies may be executed in parallel, executed sequentially, or one of the retrieval strategies may be selected for execution based on weights of the retrieval strategies, for example, selecting a retrieval strategy having a highest weight. The retrieval operation may include, but is not limited to, at least one of tag-based retrieval, keyword-based retrieval, vector-based retrieval, or knowledge graph-based retrieval. The retrieval operations may be performed in parallel or in series, and the present disclosure does not impose a specific limitation in this regard.

In some embodiments, the processing model in the electronic device may further be invoked to perform: performing corresponding processing on retrieval results obtained through the retrieval operation based on target scoring data of the electronic device, to obtain target retrieval results.

The target scoring data may represent a hardware performance score of the electronic device or a current resource usage score, or may represent a score corresponding to a retrieval model (which may be understood as different retrieval modes corresponding to different retrieval models, such that different devices may obtain different scores when running different models).

Performing corresponding processing on retrieval results obtained through the retrieval operation based on the target scoring data of the electronic device may include: fusion processing, that is, performing deduplication and/or merging on results retrieved by different retrieval modes; performing deduplication and weighted ranking on candidate results of different strategies and outputting an optimal result or a highest-ranked result as a target output result; outputting all results or a top two results; or, selectively outputting a portion of results or all results.

In some embodiments, performing the retrieval operation in the target knowledge base according to a target retrieval strategy may include: identifying user intent represented by the target input data; obtaining target scoring data of the electronic device; determining, based on the user intent and the target scoring data, target weights corresponding to a plurality of retrieval modes; and generating the target retrieval strategy for the target input data based on the target weights.

The user intent represented by the target input data may be determined by an intent recognition model, or may be determined by a large model or a retrieval model deployed in the electronic device. The target scoring data may be determined based on hardware performance (e.g., CPU, GPU, or memory) of the device under different scenarios or configurations.

The plurality of retrieval modes may include, for example, tag-based retrieval, keyword-based retrieval, vector-based retrieval, and knowledge graph-based retrieval. Final target weights may be obtained by adjusting initial weights. Specifically, a strategy manager may dynamically compute weights of tag-based retrieval, keyword-based retrieval, vector-based retrieval, and knowledge graph-based retrieval based on hardware performance (e.g., CPU, GPU, or memory) and historical user feedback. If device performance is insufficient or certain retrieval capabilities are unavailable, corresponding weights may be adjusted.

Generating the target retrieval strategy for the target input data based on the target weights may include determining a final retrieval strategy using adjusted weights. For example, when a device does not support knowledge graph-based retrieval, a corresponding score may be adjusted to 0. In this case, the system may use other strategies, such as a keyword-based retrieval strategy and a tag-based retrieval strategy, and adjust weights of the strategies to compensate for unavailable retrieval capabilities. For example, weights of tag-based retrieval, keyword-based retrieval, and vector-based retrieval may be 0.1, 0.45, and 0.45, respectively.

In some embodiments, determining target weights corresponding to the plurality of retrieval modes based on the user intent and the target scoring data may include: configuring initial weights corresponding to the plurality of retrieval modes supported by the electronic device based on a type of the user intent; and, adjusting the initial weights based on the target scoring data to obtain the target weights respectively corresponding to the retrieval modes.

Configuring initial weights based on a type of the user intent may include determining initial weights according to a type of input data. For example, when a user inputs query content, whether as a natural sentence, keywords, or tags, preprocessing such as tokenization, stop-word removal, and synonym expansion may be performed, and an intent recognition module may determine whether the query is a tag-type, keyword-type, or semantic-type query, and whether it is related to an existing knowledge graph. Corresponding initial weights may then be assigned to different retrieval strategies (e.g., tag-based retrieval, keyword-based retrieval, or vector-based retrieval).

Adjusting the initial weights may include considering whether current hardware capability and/or software model capability of the electronic device supports all retrieval modes, which retrieval modes are unsupported, and to what extent each retrieval mode is supported, and adjusting weights accordingly.

Accordingly, generating the target retrieval strategy for the target input data based on the target weights may include: determining, based on the target weights, at least one target retrieval mode to perform the retrieval operation; when a single target retrieval mode is selected, performing the retrieval operation using the single target retrieval mode; and when multiple target retrieval modes are selected, performing a plurality of retrieval operations in series or in parallel using the multiple target retrieval modes.

In some implementations, when device performance is insufficient or certain retrieval capabilities are unavailable, weights corresponding to the retrieval capabilities may be adjusted. For example, when a device does not support knowledge graph-based retrieval, its score may be set to 0, and other strategies such as keyword-based retrieval and tag-based retrieval may be used with adjusted weights to compensate for unavailable retrieval capabilities.

When a single target retrieval mode is selected, retrieval may be performed based only on the selected retrieval mode, or certain aspects of other retrieval strategies may be incorporated into the selected retrieval mode. When multiple target retrieval modes are selected, a determination may be made as to whether to perform retrieval operations in parallel or in series, based on device resource conditions (e.g., whether parallel or serial execution is supported) or user requirements (e.g., prioritizing efficiency and speed for parallel execution or prioritizing accuracy for serial execution).

In some embodiments, determining retrieval modes used to perform the retrieval operation based on the target weights may include: adjusting initial weights of respective retrieval modes based on the target scoring data according to different proportions to obtain the target weights, where the proportions are related to retrieval modes compatible with current performance of the electronic device; determining retrieval modes having target weights greater than a first threshold as retrieval modes used to perform the retrieval operation; and/or, when a target weight of a first retrieval mode is adjusted to 0, readjusting weights of at least one of remaining retrieval modes based on an initial weight of the first retrieval mode.

When the device lacks a certain retrieval capability (e.g., tag-based retrieval), capability deficiencies may be compensated by keyword mapping or semantic transformation mechanisms. For example, when a device does not support knowledge graph-based retrieval, its score may be set to 0, and other strategies such as keyword-based retrieval and tag-based retrieval may be used with adjusted weights to compensate for unavailable retrieval capabilities.

In some embodiments, performing the retrieval operation in the target knowledge base according to the target retrieval strategy may include at least one of: performing a plurality of retrieval operations in parallel or in series on the target input data based on a plurality of retrieval modes supported by the electronic device; configuring initial weights corresponding to the plurality of retrieval modes based on target feature data of the target input data, and performing a plurality of retrieval operations in series based on priorities corresponding to the initial weights, where the priorities are related to the initial weights; or, configuring different target weights for the plurality of retrieval modes based on target feature data of the target input data and the target scoring data, and determining at least one of the retrieval modes to perform the retrieval operation based on the target weights.

Performing a plurality of retrieval operations in parallel or in series based on the plurality of retrieval modes supported by the electronic device may include executing each retrieval mode, and filtering and processing final retrieval results based on the target weights.

Configuring initial weights corresponding to the plurality of retrieval modes based on target feature data of the target input data may include determining initial weights directly based on specific features of the input data, such as tags, types, key content, or sentence structures (e.g., for knowledge graph-related queries). The target feature data is not necessarily the intent type obtained after intent recognition.

In some embodiments, performing corresponding processing on retrieval results obtained through the retrieval operation based on the target scoring data of the electronic device may include: determining target weights corresponding to respective retrieval modes based on the target scoring data; performing fusion processing on retrieval results obtained through respective retrieval modes based on the target weights to output a target retrieval result; or, performing weighted ranking on retrieval results obtained through respective retrieval modes based on the target weights and selecting retrieval results within a target sequence as the target retrieval result.

The fusion processing may be understood as merging processing, which may further include deduplication processing.

Performing weighted ranking on retrieval results obtained through respective retrieval modes based on the target weights may include, for example, adjusting an initial semantic matching (corresponding to vector-based retrieval) score of 0.6 to a higher value (e.g., 0.9) based on hardware scoring. Accordingly, a final allocable score of the vector-based retrieval strategy may be increased to 0.9. When device computing capability is relatively strong, more resources may be allocated to semantic matching (vector-based retrieval), thereby increasing its influence in result ranking. For semantic-type queries, such weighting better matches actual requirements.

The number and order of output target retrieval results may be determined based on requirements, output display area, or user preferences.

In some embodiments, the electronic device may further be configured to perform at least one of: in response to obtaining feedback information of a target user regarding the target retrieval result, adjusting weight parameters corresponding to respective retrieval modes based on the feedback information; adjusting weight parameters corresponding to respective retrieval modes based on target historical retrieval feedback data; or, performing corresponding processing on retrieval results obtained through the retrieval operation based on the target scoring data and the target historical retrieval feedback data, to obtain the target retrieval result. The weight parameters may be initial weights or target weights, and the target historical retrieval feedback data may be user feedback data in historical retrieval records.

The embodiments in the present specification are described in a progressive manner, with each embodiment focusing on differences from other embodiments. Similar portions among the embodiments may be referenced to each other. For apparatus embodiments, descriptions are relatively concise, and reference may be made to corresponding method embodiments.

It should be noted that relational terms such as “first” and “second” are used herein only to distinguish one entity or operation from another, and do not necessarily imply any actual relationship or order between the entities or operations. Furthermore, the terms “include,” “comprise,” or any variations thereof are intended to cover a non-exclusive inclusion, such that a process, method, article, or apparatus that includes a plurality of elements not only includes those elements, but may also include other elements not expressly listed or inherent to such process, method, article, or apparatus. Without further limitation, an element defined by the phrase “including a …” does not exclude the presence of additional identical elements in the process, method, article, or apparatus that includes the element.

Steps of methods or algorithms described in connection with embodiments disclosed herein may be implemented directly in hardware, in software modules executed by a processor, or in a combination thereof. Software modules may reside in RAM, memory, ROM, electrically programmable ROM, electrically erasable programmable ROM, registers, hard disks, removable disks, CD-ROM, or any other form of storage medium known in the art.

The foregoing description of the disclosed embodiments enables those skilled in the art to implement or use the present disclosure. Various modifications to these embodiments will be apparent to those skilled in the art, and the general principles defined herein may be applied to other embodiments without departing from the spirit or scope of the present disclosure. Accordingly, the present disclosure is not intended to be limited to the embodiments shown herein, but is to be accorded the broadest scope consistent with the principles and novel features disclosed herein.

What is claimed is:

1. An interactive processing method, comprising:
in response to obtaining target input data, retrieving, from a target knowledge base, first memory data and second memory data that match the target input data,
wherein the target input data is data input to a target application, and the target application is capable of providing an artificial intelligence service or invoking at least one processing model to provide an artificial intelligence service, the at least one processing model comprising a target processing model; and
performing generation processing on the target input data with reference to the first memory data and the second memory data, to obtain a target response result matching a target user intent,
wherein configuration parameters respectively associated with the first memory data and the second memory data in the target knowledge base are different, and the target user intent is determined at least based on the target input data.

2. The method according to claim 1, wherein retrieving, from the target knowledge base, the first memory data and the second memory data that match the target input data comprises:
performing vectorization processing on the target input data, to obtain first vectorized data; and
retrieving a plurality of different data sources from the target knowledge base based on the first vectorized data to obtain the first memory data and the second memory data based on the plurality of different data sources, the plurality of different data sources comprising at least a first data source and a second data source,
wherein information in at least one data field differs among the plurality of different data sources, and retrieval modes for the plurality of different data sources are the same or different.

3. The method according to claim 2, wherein retrieving the plurality of different data sources from the target knowledge base based on the first vectorized data to obtain the first memory data and the second memory data comprises:
retrieving, from the target knowledge base, the first data source in a first retrieval mode by using the first vectorized data, to obtain the first memory data, wherein the first data source is a data set obtained by performing a first processing on first user data of a target user acquired within a first time period; and
retrieving, from the target knowledge base, the second data source in a second retrieval mode by using the first vectorized data, to obtain the second memory data, wherein the second data source is a data set obtained by performing a second processing on second user data of the target user acquired within a second time period, or the second data source is a data set obtained by performing a third processing on the first data source,
wherein the first retrieval mode and the second retrieval mode are the same or different, the first time period is later than the second time period, and the first processing is different from the second processing.

4. The method according to claim 3, wherein performing the first processing on the first user data of the target user acquired within the first time period to obtain the first data source comprises:
performing vectorization processing on the first user data of the target user acquired within the first time period, to obtain a plurality of sets of second vectorized data;
performing first clustering processing on the plurality of sets of second vectorized data to obtain a plurality of first vectorized data sets;
performing first summary generation processing on the plurality of first vectorized data sets to obtain a first summary data set; and
performing extraction processing on the first summary data set and the first user data according to a first data structure, to obtain the first data source.

5. The method according to claim 4, further comprising at least one of:
after obtaining the plurality of sets of second vectorized data, performing extraction processing on the plurality of sets of second vectorized data according to the first data structure, to obtain the first data source;
after obtaining the first summary data set, performing extraction processing on the first summary data set and the plurality of sets of second vectorized data according to the first data structure, to obtain the first data source; or
performing merging and/or deduplication processing on event data obtained by the extraction processing, to obtain the first data source.

6. The method according to claim 3, wherein performing the third processing on the first data source to obtain the second data source comprises:
performing second clustering processing on the first data source to obtain a plurality of second vectorized data sets;
performing second summary generation processing on the plurality of second vectorized data sets to obtain a second summary data set; and
performing extraction processing or third summary generation processing on the second summary data set and the first data source according to a second data structure, to obtain the second data source.

7. The method according to claim 3, further comprising at least one of:
processing the first data source into the second data source according to a first time interval;
performing merging and/or deduplication processing on the second data source based on the first data source;
invoking different processing models to perform vectorization processing on corresponding types of user data; or
associating user data or vectorized data corresponding to the first data source with user data or vectorized data corresponding to the second data source.

8. The method according to claim 1, wherein performing the generation processing on the target input data with reference to the first memory data and the second memory data comprises at least one of:
using the first memory data and the second memory data as knowledge base data of the target processing model, and invoking the knowledge base data by the target processing model to perform the generation processing on the target input data;
updating prompt data corresponding to the target input data based on the first memory data and the second memory data, and performing generation processing on updated prompt data using the target processing model;
optimizing user intent corresponding to the target input data based on the first memory data and the second memory data, and performing generation processing on optimized target user intent using the target processing model;
performing model parameter adjustment processing on the target processing model by using the first memory data and the second memory data, and performing generation processing on the target input data using the target processing model after adjustment; or
adjusting a weight of target data in the target input data by using the first memory data and the second memory data, and performing generation processing on the target input data after adjustment using the target processing model.

9. The method according to claim 1, wherein performing generation processing on the target input data with reference to the first memory data and the second memory data comprises at least one of:
generating third memory data based on weight parameters respectively corresponding to the first memory data and the second memory data;
performing generation processing on the target input data by invoking the target processing model based on the third memory data, to obtain the target response result; or
performing optimization processing on a response result obtained by the target processing model processing the target input data based on the third memory data, to obtain the target response result.

10. An electronic device, comprising:
one or more processors; and
a memory storing instructions that, when executed by the one or more processors, cause the electronic device to perform operations comprising:
in response to obtaining target input data, retrieving, from a target knowledge base, first memory data and second memory data that match the target input data,
wherein the target input data is data input to a target application, and the target application is capable of providing an artificial intelligence service or invoking at least one processing model to provide an artificial intelligence service, the at least one processing model comprising a target processing model; and
performing generation processing, by the target processing model, on the target input data with reference to the first memory data and the second memory data, to obtain a target response result matching a target user intent,
wherein configuration parameters respectively associated with the first memory data and the second memory data in the target knowledge base are different, and the target user intent is determined at least based on the target input data.

11. The electronic device according to claim 10, wherein the one or more processors are further configured to perform:
performing vectorization processing on the target input data to obtain first vectorized data; and
retrieving a plurality of different data sources from the target knowledge base based on the first vectorized data, and obtaining the first memory data and the second memory data based on the plurality of different data sources, the plurality of different data sources comprising at least a first data source and a second data source,
wherein information in at least one data field differs among the plurality of different data sources, and retrieval modes for the plurality of different data sources are the same or different.

12. The electronic device according to claim 11, wherein the one or more processors are further configured to perform:
retrieving, from the target knowledge base, the first data source in a first retrieval mode by using the first vectorized data, to obtain the first memory data, wherein the first data source is a data set obtained by performing a first processing on first user data of a target user acquired within a first time period; and
retrieving, from the target knowledge base, the second data source in a second retrieval mode by using the first vectorized data, to obtain the second memory data, wherein the second data source is a data set obtained by performing a second processing on second user data of the target user acquired within a second time period, or the second data source is a data set obtained by performing a third processing on the first data source,
wherein the first retrieval mode and the second retrieval mode are the same or different, the first time period is later than the second time period, and the first processing is different from the second processing.

13. The electronic device according to claim 12, wherein the one or more processors are further configured to perform:
performing vectorization processing on the first user data of the target user acquired within the first time period, to obtain a plurality of sets of second vectorized data;
performing first clustering processing on the plurality of sets of second vectorized data to obtain a plurality of first vectorized data sets;
performing first summary generation processing on the plurality of first vectorized data sets to obtain a first summary data set; and
performing extraction processing on the first summary data set and the first user data according to a first data structure, to obtain the first data source.

14. The electronic device according to claim 13, wherein the one or more processors are further configured to perform at least one of:
after obtaining the plurality of sets of second vectorized data, performing extraction processing on the plurality of sets of second vectorized data according to the first data structure, to obtain the first data source;
after obtaining the first summary data set, performing extraction processing on the first summary data set and the plurality of sets of second vectorized data according to the first data structure, to obtain the first data source; or
performing merging and/or deduplication processing on event data obtained by the extraction processing, to obtain the first data source.

15. The electronic device according to claim 12, wherein the one or more processors are further configured to perform:
performing second clustering processing on the first data source to obtain a plurality of second vectorized data sets;
performing second summary generation processing on the plurality of second vectorized data sets to obtain a second summary data set; and
performing extraction processing or third summary generation processing on the second summary data set and the first data source according to a second data structure, to obtain the second data source.

16. The electronic device according to claim 12, wherein the one or more processors are further configured to perform at least one of:
processing the first data source into the second data source according to a first time interval;
performing merging and/or deduplication processing on the second data source based on the first data source;
invoking different processing models to perform vectorization processing on corresponding types of user data; or
associating user data or vectorized data corresponding to the first data source with user data or vectorized data corresponding to the second data source.

17. The electronic device according to claim 10, wherein the one or more processors are further configured to perform at least one of:
using the first memory data and the second memory data as knowledge base data of the target processing model, and invoking the knowledge base data by the target processing model to perform the generation processing on the target input data;
updating prompt data corresponding to the target input data based on the first memory data and the second memory data, and performing generation processing on updated prompt data using the target processing model;
optimizing user intent corresponding to the target input data based on the first memory data and the second memory data, and performing generation processing on optimized target user intent using the target processing model;
performing model parameter adjustment processing on the target processing model by using the first memory data and the second memory data, and performing generation processing on the target input data using the target processing model after adjustment; or
adjusting a weight of target data in the target input data by using the first memory data and the second memory data, and performing generation processing on the target input data after adjustment using the target processing model.

18. A non-transitory computer-readable storage medium storing instructions that, when executed by at least one processor, cause the at least one processor to perform operations comprising:
in response to obtaining target input data, retrieving, from a target knowledge base, first memory data and second memory data that match the target input data,
wherein the target input data is data input to a target application, and the target application is capable of providing an artificial intelligence service or invoking at least one processing model to provide an artificial intelligence service, the at least one processing model comprising a target processing model; and
performing generation processing, by the target processing model, on the target input data with reference to the first memory data and the second memory data, to obtain a target response result matching a target user intent,
wherein configuration parameters respectively associated with the first memory data and the second memory data in the target knowledge base are different, and the target user intent is determined at least based on the target input data.

19. The storage medium according to claim 18, wherein the at least one processor is further configured to perform:
performing vectorization processing on the target input data to obtain first vectorized data; and
retrieving a plurality of different data sources from the target knowledge base based on the first vectorized data to obtain the first memory data and the second memory data based on the plurality of different data sources, the plurality of different data sources comprising at least a first data source and a second data source,
wherein information in at least one data field differs among the plurality of different data sources, and retrieval modes for the plurality of different data sources are the same or different.

20. The storage medium according to claim 19, wherein the at least one processor is further configured to perform:
retrieving, from the target knowledge base, the first data source in a first retrieval mode by using the first vectorized data, to obtain the first memory data, wherein the first data source is a data set obtained by performing a first processing on first user data of a target user acquired within a first time period; and
retrieving, from the target knowledge base, the second data source in a second retrieval mode by using the first vectorized data, to obtain the second memory data, wherein the second data source is a data set obtained by performing a second processing on second user data of the target user acquired within a second time period, or the second data source is a data set obtained by performing a third processing on the first data source,
wherein the first retrieval mode and the second retrieval mode are the same or different, the first time period is later than the second time period, and the first processing is different from the second processing.
